(19) United States
(12) Patent Application Publication
(10) Pub. No.: US 2023/0344037 A1
(43) Pub. Date: Oct. 26, 2023

(54) BATTERY MODULE HAVING A HOUSING WITH COOLANT JACKETS

(71) Applicant: SAMSUNG SDI CO., LTD., Yongin-si (KR)

(72) Inventor: Bernhard HADLER, Feldkirchen/Graz (AT)

(21) Appl. No.: 18/137,260

(22) Filed: Apr. 20, 2023

(30) Foreign Application Priority Data
Apr. 22, 2022 (EP) 22169361.7
Apr. 17, 2023 (KR) 10-2023-0050283

(51) Int. Cl. H01M 10/6568; H01M 50/209; H01M 50/271; H01M 50/289; H01M 10/613; H01M 10/625

(52) U.S. Cl. CPC H01M 10/6568; H01M 50/209; H01M 50/271; H01M 50/289; H01M 10/613; H01M 10/625; H01M 2220/20; B60K 1/04

(57) ABSTRACT

A battery module includes: a base portion extending along a first virtual plane that is perpendicular to a first direction, the base portion including a plurality of indentations protruding against the first direction; a base cover extending along a second virtual plane that is parallel to the first virtual plane and arranged in front of the first virtual plane when viewing into the first direction, the base cover being spaced apart from each of the indentations; and a plurality of groups of battery cells. Each of the indentations forms a compartment configured to accommodate at least one of the groups of battery cells, and each of the groups of battery cells is accommodated in one of the compartments. A space is formed between neighboring ones of the indentations.

### CROSS-REFERENCE TO RELATED APPLICATION

This application claims priority to and the benefit of European Patent

Application No. 22169361.7, filed in the European Patent Office on Apr. 22, 2022, and Korean Patent Application No. 10-2023-0050283, filed in the Korean Intellectual Property Office on Apr. 17, 2023, the entire content of both of which are incorporated herein by reference.

### BACKGROUND

### 1. Field

Aspects of embodiments of the present disclosure relate to a battery module having a housing with coolant jackets.

### 2. Description of the Related Art

Recently, vehicles for transportation of goods and peoples have been developed that use electric power as a source for motion. Such an electric vehicle is an automobile that is propelled by an electric motor using energy stored in rechargeable batteries. An electric vehicle may be solely powered by batteries or may be a hybrid vehicle powered by, for example, a gasoline generator or a hydrogen fuel power cell. A hybrid vehicle may include a combination of electric motor and conventional combustion engine. Generally, an electric-vehicle battery (EVB or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supplies for small electronic devices, such as cellular phones, notebook computers, and camcorders, while high-capacity rechargeable batteries are used as power supplies for electric and hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, such as cylindrical or rectangular, may be selected based on the battery's intended purpose. Lithium-ion (and similar lithium polymer) batteries, widely known via their use in laptops and consumer electronics, dominate the most recent electric vehicles in development.

Rechargeable batteries may be used as a battery module formed of a plurality of unit battery cells coupled together in series and/or in parallel to provide a high energy content, such as for motor driving of a hybrid vehicle. The battery module may be formed by interconnecting the electrode terminals of the plurality of unit battery cells in a manner depending on a desired amount of power and to realize a high-power rechargeable battery.

Battery modules can be constructed either in a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage. The battery modules may include submodules with a plurality of stacked battery cells, and each stack includes cells connected in parallel that are, in turn, connected in series (XpYs) or cells connected in series that are, in turn, connected in parallel (XsYp).

A battery pack is a set of any number of (usually identical) battery modules. The battery modules may be configured in series, parallel, or a mixture of both to deliver the desired voltage, capacity, and/or power density. Components of a battery pack include the individual battery modules and the interconnects, which provide electrical conductivity between the battery modules.

A battery system may also include a battery management system (BMS), which is any suitable electronic system that is configured to manage the rechargeable battery, battery module, and battery pack, such as by protecting the batteries from operating outside their safe operating area, monitoring their states, calculating secondary data, reporting that data, controlling its environment, authenticating it, and/or balancing it. For example, the BMS may monitor the state of the battery as represented by voltage (e.g., a total voltage of the battery pack or battery modules and/or voltages of individual cells), temperature (e.g., an average temperature of the battery pack or battery modules, coolant intake temperature, coolant output temperature, and/or temperatures of individual cells), coolant flow (e.g., flow rate and/or cooling liquid pressure), and current. Additionally, the BMS may calculate values based on the above parameters, such as minimum and maximum cell voltage, state of charge (SOC) or depth of discharge (DOD) to indicate the charge level of the battery, state of health (SOH; a variously-defined measurement of the remaining capacity of the battery as % of the original capacity), state of power (SOP; the amount of power available for a defined time interval given the current power usage, temperature and other conditions), state of safety (SOS), maximum charge current as a charge current limit (CCL), maximum discharge current as a discharge current limit (DCL), and internal impedance of a cell (to determine open circuit voltage).

The BMS may be centralized such that a single controller is connected to the battery cells through a multitude of wires. In other examples, the BMS may be distributed, with a BMS board installed at each cell, with just a single communication cable between the battery and a controller. In yet other examples, the BMS may have a modular construction including a few controllers, each handling a certain number of cells while communicating between the controllers. Centralized BMSs are most economical but are least expandable and are plagued by a multitude of wires. Distributed BMSs are the most expensive but are simplest to install and offer the cleanest assembly. Modular BMSs provide a compromise of the features and problems of the other two topologies.

A BMS may protect the battery pack from operating outside its safe operating area. Operation outside the safe operating area may be indicated by over-current, over-voltage (during charging), over-temperature, under-temperature, over-pressure, and ground fault or leakage current detection. The BMS may prevent the battery from operating outside its safe operating parameters by including an internal switch (e.g., a relay or solid-state device) that opens if the battery is operated outside its safe operating parameters, requesting the devices to which the battery is connected to reduce or even terminate using the battery, and actively controlling the environment, such as through heaters, fans, air conditioning or liquid cooling.

The mechanical integration of such a battery pack requires appropriate mechanical connections between the individual components (e. g., within battery modules and between them and a supporting structure of the vehicle). These connections must remain functional and safe during the average service life of the battery system. Further, installation space and interchangeability requirements must be met, especially in mobile applications.

Mechanical integration of battery modules may be achieved by providing a carrier framework and by positioning the battery modules thereon. Fixing the battery cells or battery modules may be achieved by fitted depressions in the framework or by mechanical interconnectors, such as bolts or screws. In some cases, the battery modules are confined by fastening side plates to lateral sides of the carrier framework. Further, cover plates may be fixed atop and below the battery modules.

The carrier framework of the battery pack is mounted to a carrying structure of the vehicle. When the battery pack is to be fixed at the bottom of the vehicle, the mechanical connection may be established from the bottom side by, for example, bolts passing through the carrier framework of the battery pack. The framework is usually made of aluminum or an aluminum alloy to lower the total weight.

Conventional battery systems, despite any modular structure, usually include a battery housing that acts as an enclosure to seal the battery system against the environment while providing structural protection of the battery system's components. Housed battery systems are usually mounted as a whole into their application environment, such as an electric vehicle. Thus, the replacement of defective system parts, such as a defective battery submodule, requires dismounting the whole battery system and removal of its housing first. Even defects of small and/or cheap system parts might then require dismounting and replacement of the entire battery system and its separate repair. Because high-capacity battery systems are expensive, large, and heavy, said procedure proves burdensome and the storage, such as in the mechanic's workshop, of the bulky battery systems becomes difficult.

An active or passive thermal management system to provide thermal control of the battery pack is often included to safely use the at least one battery module by efficiently emitting, discharging, and/or dissipating heat generated from its rechargeable batteries. If the heat emission, discharge, and/or dissipation is not sufficiently performed, temperature deviations may occur between respective battery cells, such that the battery module may no longer generate a desired (or designed) amount of power. In addition, an increase of the internal temperature can lead to abnormal reactions occurring therein, and thus, charging and discharging performance of the rechargeable battery deteriorates and the life-span of the rechargeable battery is shortened. Thus, cell cooling for effectively emitting, discharging, and/or dissipating heat from the cells is important.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. These exothermic reactions include combustion of flammable gas compositions within the battery housing. For example, when a cell is heated above a critical temperature (typically above about 150° C.), the cell can transition into a thermal runaway. The initial heating may be caused by a local failure, such as a cell internal short circuit, heating from a defective electrical contact, or short circuit to a neighboring cell. During the thermal runaway, a failed battery cell, such as a battery cell that has a local failure, may reach a temperature exceeding about 700° C. Further, large quantities of hot gas are ejected (or emitted) from inside of the failed battery cell through the venting opening in the battery housing into the battery pack. The main components of the vented gas are H₂, CO₂, CO, electrolyte vapor, and other hydrocarbons. The vented gas is therefore flammable and potentially toxic. The vented gas also causes a gas-pressure to increase inside the battery pack.

Conventional cooling systems are flat and are usually placed on the bottom of the cell. Different technologies are used for creating a flat cooler. However, in view of the increasing requirements for the performance of battery modules, such conventional cooling systems may not be sufficient, for example, during fast charging, acceleration, high speed operation, or the like.

### SUMMARY

There is a desire to increase the efficiency of a cooling system within a battery module, including in view of high-performance events (e.g., fast charging, acceleration, high speed operation) or thermal propagation. Accordingly, embodiments of the present disclosure overcome or mitigated at least the above-described drawbacks of the prior art and provide a battery pack having improved characteristics in at least this regard.

The present disclosure is defined by the appended claims and their equivalents. Any disclosure lying outside the scope of the claims and their equivalents is intended for illustrative and/or comparative purposes.

According to a first embodiment of the present disclosure, a battery module includes: a base portion, a base cover, and a plurality of groups of battery cells. The base portion extends along a first virtual plane that is perpendicular to a first direction. The base portion includes a plurality of indentations protruding against the first direction (i.e., protruding in the negative first direction). Each of the indentations forms a compartment configured to accommodate a group of battery cells. Each of the groups of battery cells is accommodated in one of the compartments. A space is formed between any two neighboring ones of the indentations. The base cover extends along a second virtual plane that is parallel to the first virtual plane and is in front of the first virtual plane when viewing into the first direction. The base cover is spaced apart from each of the indentations.

According to a second embodiment of the present disclosure, a battery pack includes one or more of the battery modules according to the first embodiment.

According to a third embodiment of the present disclosure, a vehicle includes at least one battery module according to the first embodiment and/or at least one battery pack according to the second embodiment.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic top view illustrating a first embodiment of a battery module according to the present disclosure;

FIG. 2 is a schematic cross-sectional view through the first embodiment shown in FIG. 1;

FIG. 3 is another schematic cross-sectional view through the first embodiment shown in FIG. 1;

FIG. 4 is another cross-sectional view through the first embodiment shown in FIG. 1;

FIG. 5 is a perspective view of a base portion of a battery module;

FIG. 6 schematically shows parts of an embodiment of the battery module according to the disclosure;

FIG. 7A shows a schematic cross-sectional view of a battery module according to an embodiment of the present disclosure;

FIG. 7B is a perspective view of the battery module shown in FIG. 7A;

FIG. 7C is a perspective bottom view of parts of a battery module according to an embodiment of the present disclosure; and

FIG. 8 schematically illustrates a cross-sectional view through a base portion of a battery module according to an embodiment of the present disclosure.

### DETAILED DESCRIPTION

Reference will now be made, in detail, to embodiments, examples of which are illustrated in the accompanying drawings. Aspects and features of the present disclosure, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete, and will fully convey the aspects and features of the present disclosure to those skilled in the art. Accordingly, processes, elements, and techniques that are not considered necessary to those having ordinary skill in the art for a complete understanding of the aspects and features of the present disclosure may not be described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

As used herein, the term “substantially,” “about,” and similar terms are used as terms of approximation and not as terms of degree and are intended to account for the inherent deviations in measured or calculated values that would be recognized by those of ordinary skill in the art. Further, if the term “substantially” is used in combination with a feature that could be expressed using a numeric value, the term “substantially” denotes a range of ±5% of the value centered on the value.

To facilitate the description, a coordinate system with axes x, y, z may also be provided in at least some of the figures. Herein, unless explicitly defined otherwise in the context of a figure, the terms “upper” and “lower” are defined according to the x-axis. For example, the upper cover is positioned at the upper part of the x-axis, whereas the lower cover is positioned at the lower part thereof.

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements (e.g., on a PCB or another kind of circuit carrier). The conducting elements may comprise metallization (e.g., surface metallizations and/or pins) and/or may include conductive polymers or ceramics. Further electrical energy might be transmitted via wireless connections (e.g., by using electromagnetic radiation and/or light).

Further, the various components of these devices may be a process or thread, running on one or more processors, in one or more computing devices, executing computer program instructions and interacting with other system components for performing the various functionalities described herein. The computer program instructions are stored in a memory, which may be implemented in a computing device by using a standard memory device, such as, for example, a random access memory (RAM). The computer program instructions may also be stored in other non-transitory computer readable media such as, for example, a CD-ROM, flash drive, or the like.

Also, a person of skill in the art should recognize that the functionality of various computing devices may be combined or integrated into a single computing device, or the functionality of a particular computing device may be distributed across one or more other computing devices without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

A first embodiment of the present disclosure provides a battery module including: a base portion, a base cover, and a plurality of groups of battery cells. The base portion extends along a first virtual plane that is perpendicular to a first direction and includes a plurality of indentations protruding against the first direction. Each of the indentations forms a compartment configured to accommodate a group of battery cells such that each of the groups of battery cells is accommodated in one of the compartments with a space is formed between any two neighboring (e.g., adjacent) indentations. The base cover extends along a second virtual plane that is parallel to the first virtual plane and is arranged in front of the first virtual plane when viewing in the first direction, and the base cover is spaced apart from each of the indentations.

The term “virtual plane,” as used herein, denotes that the expression “plane” describes the geometry of an object, whereas a “virtual plane” is not realized as an object. The term “indentation” means that, within a certain confined area of the base portion, an embayment or a depression is formed in the base portion. Then, the compartments can each be regarded as kind of cavities that are open in the area of the first virtual plane or depressions (when viewed against the first direction). The expression “coolant” is meant to refer to a “cooling fluid.”

In accordance with a first embodiment of the present disclosure, additional side cooling of the battery cells is provided to improve the cooling system of the battery cells during high performance events (e.g., fast charging, acceleration, high speed operation) or thermal propagation.

A space between neighboring indentations (e.g., interstice) may be formed between these indentations when viewing in a direction perpendicular to the first direction. Further, a space between the base portion and the base cover may be formed with regard to the first direction. Thus, a space is formed in between the base cover and the base portion into which a coolant can be filled (or can move). The space between the base cover and the base portion is linked to the spaces between the indentations. For example, the space may include: (i) a gap between the base cover and the bottom sides of the indentations (e.g., the areas of the indentations that are closest to the base cover); and (ii) the interstices between the various indentations. Then, the coolant reaches from the gap between the base cover and the bottom sides of the indentations into the interstices between the various indentations and, thus, may cool the compartments formed by the indentations from various sides to provide a sufficient amount of coolant.

In some embodiments, the battery module may further include a top cover extending parallel to the first virtual plane and arranged opposite to the base cover with respect to the base portion. In such embodiments, the base portion is arranged in between the base cover and the top cover.

In one embodiment, the base portion is formed as one piece by injection molding or die casting.

In such an embodiment, the base potion is formed as a cast housing structure configured to accommodate a plurality of groups of battery cells. This facilitates the manufacture of the base portion and, thus, considerably reduces the costs to manufacture the battery module. Furthermore, this provides safe separation between the space provided for receiving the coolant and the space within the compartments provided for accommodating the (groups of) battery cells.

In one embodiment, the base portion is made of aluminum or an aluminum alloy. Aluminum is highly thermal conductivity, thereby improving thermal transfer. Moreover, an aluminum die cast housing (base portion) with the afore-described structure of the cooling system will allow for side cooling without major part cost increase.

In one embodiment of the battery module, the edge of the base portion is continuously connected with the base cover in a sealed manner.

Herein, the expression “in a sealed manner” is equivalent to “in a fluid-proof manner,” and the term “fluid” refers to the coolant unless otherwise noted.

For example, a circumferential gasket may be arranged between the edge of the base portion and the base cover, and the gasket may have a shape corresponding or identical to that of the edge of the base portion and being connected, in the first direction, with the edge of the base portion and being further connected, against the first direction, with the base cover. In such an embodiment, the base portion is continuously connected with the base cover by the gasket.

In other embodiments, the edge of the base portion may be welded to the base cover. In such an embodiment, the base portion is continuously connected with the base cover by welding.

In some embodiments, the base cover, when viewed along the first direction, is congruent to the base portion and positioned such that the base cover completely covers the base portion. The edge of the base portion may be sealed to the edge of the base cover. The sealing of the edge of the base portion to the edge of the base cover may be realized by a gasket having a shape corresponding or identical to that of the edge of the base portion.

In some embodiments, the edge of the base portion includes a circumferential first wall elevated against (e.g., protruding in) the first direction (e.g., towards or to the base cover). Then, the first wall may be sealed to the base cover. Additionally or alternatively, the base cover may have a second wall protruding to the base portion, and the second wall may have a shape corresponding or identical to that of the edge of the base portion. Then, the second wall may be sealed to the base portion.

An inlet may be arranged through the base cover or through the connection of the base cover with the base portion. The inlet may be configured to be connected to a coolant supply. Then, (fresh) coolant can be supplied, via the inlet, into the space formed between the base portion and the base cover. Also, an outlet may be arranged through the base cover or through the connection of the base cover with the base portion. Then, the outlet may be configured to be connected to a coolant receptacle configured for receiving coolant. Then, (used) coolant can be discharged, via the outlet, from the space formed between the base portion and the base cover into the coolant receptacle.

Herein, “fresh coolant” means coolant that has not received heat from the battery cells, and “used coolant” means coolant that has received heat from the battery cells or has moved around the indentations.

In the embodiments described herein, the roles of the “outlets” and “inlets” can be switched; for example, any “inlet” can be regarded as an “outlet,” if, at the same time, any “outlet” is regarded as an “inlet.” The above-described topologies of the “space system” (e.g., the system of the space formed between the base cover and the base portion linked to the interstices between the various indentations, irrespectively of the special geometric design of a certain embodiment) are not affected by such a modification.

In one embodiment of the battery module, the base cover and the base portion are formed together, as one piece, by injection molding or die casting.

This facilitates the manufacture of the complete battery module, and thus, considerably reduces the costs to manufacture the battery module. Furthermore, this increases the sealing between the base cover and the base portion because no additional members for sealing (such as a gasket) are required. The piece including the base cover and the base portion may be made of aluminum or an aluminum alloy. An aluminum die cast housing (e.g., the base portion together with the base cover) with a cooling system with a structure as described in above will allow for side cooling without major part cost increase.

In one embodiment of the battery module, each of the indentations has a base area, and the base area is the area of the indentation having a maximal distance to the first virtual plane.

The base area may be equivalently defined as the area of the indentation having a minimal distance to the second virtual plane.

In one embodiment of the battery module, for each or at least for one of the indentations, the base area extends parallel to the first virtual plane.

In other words, all or some of the indentations have an area having a maximal distance to the first virtual plane and extending parallel to the first virtual plane. Then, each of the compartments has a base side parallel to the first virtual plane.

In one embodiment of the battery module, the base areas of each indentations have the same distance to the first virtual plane.

For example, with respect to a distance (e.g., a predefined distance), all indentations have an area having a maximal distance to the first virtual plane (or, equivalently, a minimal distance to the second virtual plane) and spaced apart from the first virtual plane by the distance. Then, measured from the first virtual plane along the first direction, all the compartments have the same depth.

In one embodiment of the battery module, each or some of the base areas have an oval or circular shape or a rectangular shape.

For example, in an embodiment having a circular base area arranged parallel to the first virtual plane, the compartment formed by an indentation then has a cylindrical shape, and the cylinder is closed from one side (the base area) and open at the other side. This may fit groups of battery cells each having a cylindrical shape and stacked (with their sides) together along the first direction. Then, the group of stacked cylindrical battery cells can be received by (or accommodated in) the cylindrical compartment after being inserted into the cylindrical compartment against the first direction (provided, the radius of cylindrical shape of the battery cells is smaller than the radius of the circular base). In another embodiment having a rectangular base area arranged parallel to the first virtual plane, the indentation is shaped as a cuboid, and the cuboid has one open side (the open side lying in the first virtual plane). This may fit for groups of stacked battery cells each having a prismatic (cuboid) shape.

In one embodiment of the battery module, each or some of the indentations has side walls extending parallel to the first direction.

In embodiments, each or some of the indentations may have inclined side walls. For example, the side walls may be inclined, with respect to the base area, by an angle greater than about 90° (e.g., by an angle of about 95°, about 100°, about 105°, or about 110°). For example, in an embodiment having a rectangular base area arranged parallel to the first virtual plane, the indentation has four side walls, each of the side walls extending between one of the edges of the rectangular base area and the first virtual plane. The compartment formed by this indentation has the shape of a frustum protruding, from the first virtual plane, against the first direction, with the base of the frustum being open and lying in the first virtual plane. The side walls may be arranged with different angles with respect to the base area. For example, two opposite side walls may be arranged at an angle of about 90° with respect to the base area, and the two other opposite side walls may be arranged at an angle greater than about 90° with respect to the base area. In an embodiment having a circular base area arranged parallel to the first virtual plane, the indentation (and, thus, the compartment formed by this indentation) has the shape of a conical frustum protruding, from the first virtual plane, against the first direction, with the base of the conical frustum being open and lying in the first virtual plane.

The indentations may be identically shaped. Further, the groups of battery cells may be identically shaped. Each of the groups of battery cells can then be accommodated in any one of the compartments (provided, the dimensions of the groups of cells are chosen such that the groups of cells fit into one of the compartments).

In one embodiment of the battery module, the indentations are arranged, with regard to the first virtual plane, in a two-dimensional periodic pattern (e.g., in a matrix).

For example, the indentations may be arranged periodically with regard to a second direction (y) and, at the same time, may be arranged periodically with regard to a third direction (z). The second direction (y) and the third direction (z) may each be perpendicular to the first direction (x). The third direction (z) may be perpendicular to the second direction (y). This arrangement may be particularly suitable when the base area of all of the indentations has a rectangular shape. In other embodiments, the third direction may have an angle of about 60° to the second direction. This arrangement may be particularly suitable when the base area of all of the indentations has a circular shape.

In one embodiment of the battery module, the side of base cover facing the base portion includes an elevated structure forming one or more streaming beds or semi-tube-like structures configured to guide a coolant across the side along a path.

In one embodiment of the battery module, the sides of at least some of the base areas facing the base cover include an elevated structure forming one or more streaming beds or semi-tube-like structures configured to guide a coolant across the side along a path.

Such elevated structures may help to guide the coolant in the space between the base cover and the indentations in a non-linear way to distribute the fresh coolant within this space and, thus, increase a uniformly cooling effect on the compartments.

In one embodiment of the battery module, in all or at least some of the groups of battery cells, the battery cells are stacked along the first direction (x).

In one embodiment of the battery module, in all or at least some of the groups of battery cells, the battery cells are stacked in a direction perpendicular to the first direction (x).

For example, when the compartments have an essentially cuboid-like shape, the battery cells of a group accommodated in one of the compartments may be stacked along a direction perpendicular to one of the side faces of the compartment. In another embodiment, when the compartments have an essentially cylindrical shape, a group of battery cells accommodated in one of the compartments may include battery cells each having a cylindrical shape (with the center axis being parallel to the first direction) and being stacked together along the first direction.

A second embodiment of the present disclosure provides a battery pack includes one or more of the battery modules according to the first embodiment.

The battery pack may further include a battery management system (BMS) configured to monitor and control the battery cells in the battery pack as described in the introductory portion of the present disclosure and/or a plurality of detectors (e.g., sensor) for supervising the temperature or the currency of individual battery cells or of groups of battery cells.

A third embodiment of the present disclosure provides a vehicle including at least one battery module according to the first embodiment and/or at least one battery pack according to the second embodiment.

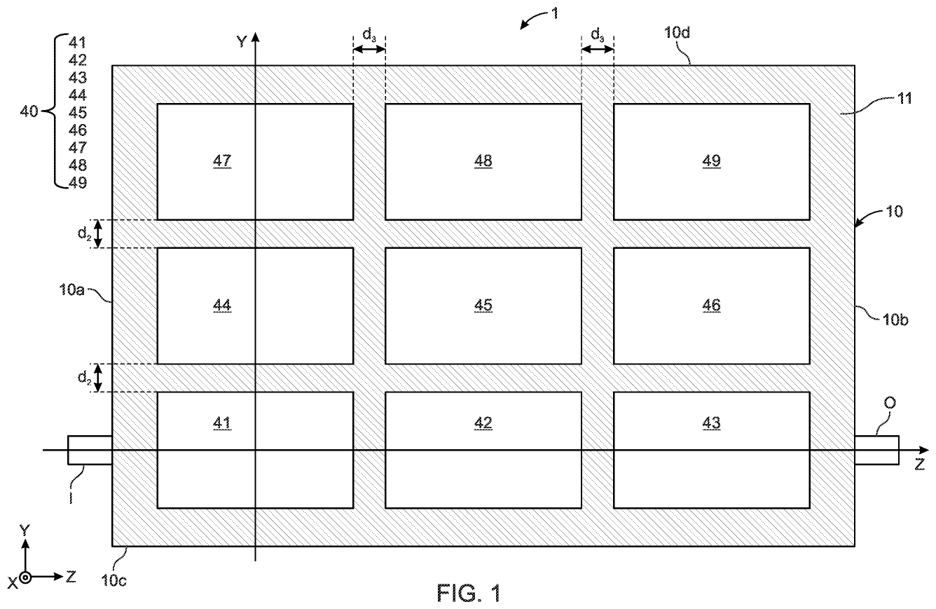

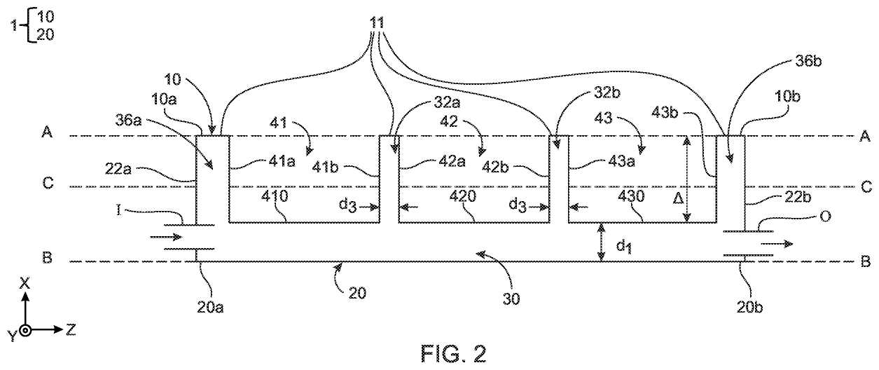

FIG. 1 is a schematic top view illustrating a first embodiment of the battery module 1 according to the present disclosure. Further, FIG. 2 is a schematic cross-sectional view through the first embodiment shown in FIG. 1 taken along the arrow Z. To facilitate the following description, a Cartesian coordinate system with the x, y, and z axes is depicted in the figures. The battery module 1 includes a base portion 10 and a base cover 20. In the top view of FIG. 1, only the base portion 10 is visible because the base cover 20 is completely hidden by the base portion 10 (except for an inlet I and an outlet O, which will be described below). The base portion 10 is essentially a plate 11 extending parallel to the y-z-plane of the coordinate system. With reference to FIG. 2, the plate 11 extends along a first virtual plane perpendicular to the drawing plane of FIG. 2 and intersecting the drawing plane of FIG. 2 along the line A-A. The plate 11 includes a plurality of indentations 40 protruding against the x-direction (e.g., being recessed in the −x direction).

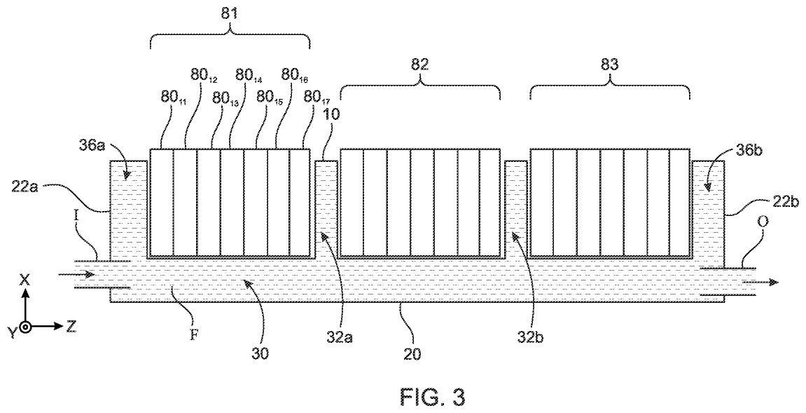

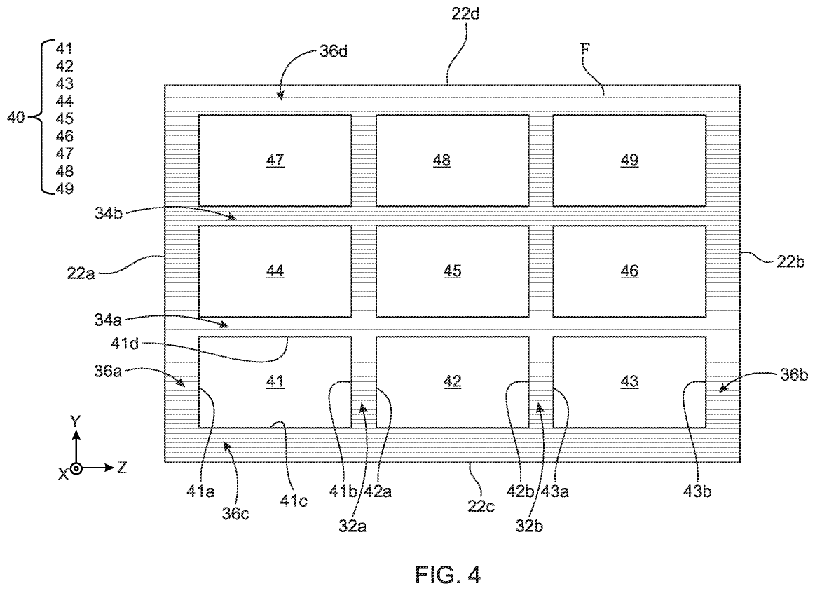

Each of the indentations may have a cuboid shape that forms a compartment with one open side (viz., the open side lying in the first virtual plane). Accordingly, as can be seen from FIG. 1, each of the compartments 41, 42, 43, 44, 45, 46, 47, 48, 49 has a rectangular shape in a top view. Further, referring to FIG. 2, it can be seen that the cross-sectional shape of each of the compartments 41, 42, 43, 44, 45, 46, 47, 48, 49 is rectangular. However, the upper side (with respect to the orientation shown in FIG. 2) of the compartments are each open. A base area 410, 420, 430 (e.g., a bottom area with respect to FIG. 2), that is, an area having a maximal distance to the first virtual plane, is formed parallel to the first virtual plane at a distance Δ for each of the indentations (or compartments 41, 42, 43, 44, 45, 46, 47, 48, 49). Also, the compartments 41, 42, 43, 44, 45, 46, 47, 48, 49 are each confined by (or defined by) sidewalls orientated perpendicular to the first virtual plane. For example, a first compartment 41 is confined, along the z-direction, by two side walls 41a and 41b arranged opposite to each other with respect to the base area 410 of the first compartment 41, and the side walls 41a and 41b are orientated parallel to the x-y-plane of the coordinate system. A pair of further sidewalls 41c and 41d confining the first compartment 41 with respect to the y-direction (see, e.g., FIG. 4) is not visible in FIG. 2 because the further sidewalls 41c and 41d are arranged parallel to the x-z-plane of the coordinate system. Hence, each of the compartments 41, 42, 43, 44, 45, 46, 47, 48, 49 is configured to accommodate a group of battery cells (see, e.g., FIG. 3) when each group of battery cells has an overall cuboid shape (e.g., the group of battery cells includes a plurality of prismatic battery cells stacked together in a flush fitting way, as shown in FIG. 3 explicitly for a first group of battery cells 81 accommodated in the first compartment 41).

In the illustrated embodiment, the indentations (forming the compartments 41, 42, 43, 44, 45, 46, 47, 48, 49) are identically shaped as each other. Further, the indentations are arranged on (or formed in) the plate 11 in a two-dimensional periodic pattern. The indentations/compartments may be arranged in a matrix with reference to the top view provided by FIG. 1. For example, along the y-direction, the compartments are spaced apart from each other by a distance d₂. The compartment 41 shown in the left bottom corner of the matrix of compartments as shown in FIG. 1 is spaced apart from the adjacent compartment 44 with respect to the y-direction by distance d₂, and the compartment 44, in turn, is spaced apart from the compartment 47 arranged next to it in the y-direction likewise by the distance d₂. Thus, the afore-mentioned compartments 41, 44, and 47 are aligned periodically with respect to the y-direction (e.g., along the line indicated by the arrow Y). This applies in a similar manner to the compartments 42, 45, and 48 arranged in the center area of the plate 11 with respect to the z-direction, and to the compartments 43, 46, and 49 arranged adjacent to the right edge of the base portion 10 (with respect to FIG. 1). Correspondingly, the compartment 41 shown in the left bottom corner of the matrix of compartments as shown in FIG. 1 is spaced apart from the adjacent compartment 42 with respect to the z-direction by distance d₃, and the compartment 42, in turn, is spaced apart from the compartment 43 arranged next to it in the z-direction likewise by the distance d₃. Thus, the afore-mentioned compartments 41, 42, and 43 are aligned periodically with respect to the z-direction (e.g., along the line indicated by the arrow Z). This applies in a similar manner to the compartments 44, 45, and 46 arranged in the center area of the plate 11 with respect to the y-direction, and to the compartments 47, 48, and 49 arranged adjacent to the upper edge of the base portion 10 (as shown in FIG. 1).

In some embodiments, the circumferential edge of the base cover 20 is congruent to the circumferential edge of the base portion 10. Further, the base cover 20 is orientated such that, in the top view as provided by FIG. 1, it is completely hidden by the base portion 10. The base portion 10 and the base cover 20 may each have four (linear) side edges. For example, the base portion 10 (or, equivalently, the plate 11), has four (linear) side edges 10a, 10b, 10c, 10d. Behind each of these side edges 10a, 10b, 10c, 10d of the base portion 10, when viewed against the x-direction, a respective side edge of the base cover 20 is arranged.

The base portion 10 is connected to the base cover 20 by four side covers in a fluid-proof manner. For example, each of the side edges 10a, 10b, 10c, 10d of the base portion 10 is connected to the respective side edge of base cover 20 arranged behind the side edges 10a, 10b, 10c, 10d of the base portion 10, when viewing against the x-direction. For example, with reference to FIGS. 2 and 4, the left side edge 10a of the base portion 10 is connected to the left side edge 20a of the base cover 20 by a first side cover 22a, and, correspondingly, the right side edge 10b of the base portion 10 is connected to the right side edge 20b of the base cover 20 by a second side cover 22b arranged in parallel to the first side cover 22a. Similarly, the remaining side edges 10c, 10d of the base portion 10 are connected to respective side edges of the base cover 20 by a third side cover and a fourth side cover, respectively, arranged parallel to each other, perpendicular to the first side cover 22a and the second side cover 22b, and opposite to each other with respect to the base portion 10 and the base cover 20.

Each of the side covers may be part of the base cover 20. In other embodiments, each of the side covers may be part of the base portion 10. In yet other embodiments, some of the side covers (e.g., the first and the second side cover 22a, 22b) may be part of the base portion 10 and the remaining side covers (e.g., the third and the fourth side cover) may be part of the base cover 20. In each of these embodiments, the base portion 10 is fixed to the base cover 20 in a fluid-proof manner. For example, a gasket can be inserted between the base portion 10 and the base cover 20 along the lines at where the base portion 10 is connected to the base cover 20. The base portion 10 may be formed as one piece by injection molding or die casting. This facilitates the manufacture of the base portion 10 and, thus, considerably reduces the costs to manufacture the battery module 1. Furthermore, safe separation is provided between the space provided for receiving the coolant and the space within the compartments provided for accommodating the (groups of) battery cells.

In some embodiments, the base cover 20 and the base portion 10 may be formed together as one piece by injection molding or die casting. This facilitates the manufacture of the complete battery module 1 and, thus, considerably reduces the costs to manufacture the battery module 1. Furthermore, the sealing between the base cover 20 and the base portion 10 is improved as no additional members for sealing (such as a gasket) are necessary.

An inlet I is arranged through the first side cover 22a, which is configured to be connected to an (external) coolant supply such that coolant can flow, via the inlet I, into the space formed between the base cover 20 and the base portion 10 (as indicated by the arrow pointing into the inlet I in FIG. 3). Correspondingly, an outlet O is arranged through the second side cover 22b, which is configured to be connected with an (external) coolant receptacle such that coolant can be discharged, via the outlet O, from the space formed between the base cover 20 and the base portion 10 into the coolant receptacle (as indicated by the arrow pointing out of the outlet O in FIG. 3). The space formed between the base cover 20 and the base portion 10 may have a rather complicated structure, which will be explained below. However, in other embodiments, the inlet I and/or the outlet O may be arranged at other locations. For example, the inlet I may be positioned close to the left side edge 10a of the base portion 10, and the outlet I may be positioned close to the right side edge 10b of the base portion 10.

With reference to FIG. 2, the base cover 20 is arranged below the base portion 10 such that the base cover 20 is spaced apart from the base areas 410, 420, 430 of each of the compartments 41, 42, 43, 44, 45, 46, 47, 48, 49. In the illustrated embodiment, the base cover 20 is spaced apart from the base areas 410, 420, 430 by a distance d₁. Hence, there is a space 30 between the base cover 20 and the base areas 410, 420, 430. Also, due to the above-explained matrix-like arrangement of the compartments 41, 42, 43, 44, 45, 46, 47, 48, 49 on the base portion 10, further spaces are provided between the side walls of the compartments 41, 42, 43, 44, 45, 46, 47, 48, 49, as shown in FIGS. 2, 3, and 4. For example, a first interstice 32a is formed between the right sidewall 41b of the first compartment 41 and the left side wall 42a of the second compartment 42 (with respect to the orientation as shown in FIGS. 1 and 3). Along the z-direction, the width of the first interstice 32a is d₃. Also, a second interstice 32b is formed between the right side wall 42b of the second compartment 42 and the left side wall 43a of the third compartment 42 (with respect to the orientation as shown in FIGS. 1 and 3). Along the z-direction, the width of the second interstice 32b is likewise d₃.

Moreover, with reference to FIGS. 2 and 4, a further space is formed by a first side interstice 36a located between the first side cover 22a and the left sidewall 41a of the first compartment 41, and yet a further space is formed by a second side interstice 36b located between the second side cover 22b and the right side wall 43b of the third compartment 43. This applies in a similar manner to each of the compartments 41, 42, 43, 44, 46, 47, 48, 49 located adjacent to at least one of the side edges 10a, 10b, 10c, 10d (and, thus, adjacent to at least one of the four side covers as described above), when viewed in the top view of FIG. 1. For example, for any of these compartments, and interstice is formed between the side wall(s) adjacent to the respective side cover(s) and the respective side cover(s). Note that for any of the compartments 41, 43, 47, 49 located in a corner of the matrix-like arrangement of the compartments shown in FIGS. 1 and 3, interstices are formed at two side walls of the compartment. For example, adjacent to the first compartment 41 as shown in FIG. 4, one interstice (viz., the first interstice 36a as described above with reference to FIG. 1) is formed between the first side cover 22a and the left sidewall 41a of the first compartment 41, and a further interstice 36c is formed between the third side cover 22c and the sidewall 41c of the first compartment 41 adjacent to the third side cover 22c.

The space formed between the base cover 20 and the base portion 10 includes the space 30 between the base cover 20 and the base areas 410, 420, 430, the space 30 is connected to each of the interstices 32a, 32b formed between the various compartments 41, 42, 43, 44, 45, 46, 47, 48, 49 as well as to each of the interstices 36a, 36b, 36c, 36d formed between the side covers 22a, 22b, 22c, 22d, and the respective adjacent compartments. Further, the space 30 between the base cover 20 and the base areas 410, 420, 430 is connected to each of the above-mentioned interstices. Accordingly, the coolant filled into the space formed between the base cover 20 and the base portion 10 can move freely within the space 30 and each of the interstices. Thus, such coolant comes in contact with the base areas 410, 420, 430 of each of the compartments 41, 42, 43, 44, 45, 46, 47, 48, 49 as well as with each of the side walls of the compartments 41, 42, 43, 44, 45, 46, 47, 48, 49.

This is shown in more detail in FIGS. 3 and 4. FIG. 3 depicts the first embodiment of the battery module 1 according to the present disclosure in the same manner as FIG. 2, that is, as a schematic cross-sectional view through the first embodiment shown in FIG. 1 along the arrow Z. Additionally, however, FIG. 3 illustrates schematically the accommodation of groups of battery cells 81, 82, 83 in the compartments 41, 42, 43, respectively. In the illustrated embodiment, each group of battery cells 81, 82, 83 has a cuboid overall shape, that is, it includes a plurality of prismatic (cuboid) battery cells stacked together in a flush fitting manner. For example, the first group of battery cells 81 includes a plurality of prismatic battery cells 80₁₁, 80₁₂, 80₁₃, 80₁₄, 80₁₅, 80₁₆, 80₁₇. This applies in a corresponding manner to the second group of battery cells 82 and the third group of battery cells 83 shown in FIG. 3 as well as to each of the further groups of battery cells placed within the remaining compartments 44, 45, 46, 47, 48, 49. In the illustrated embodiment, the battery cells of each of the groups are stacked together along the z-direction. In some embodiments, the battery cells of the groups may also be stacked together along the x-direction. In such an embodiment, the compartments may have a greater depth, that is, the compartments may have a greater extension with regard to the x-direction. The groups of battery cells may be electrically interconnected to each other. For example, the groups of battery cells may be electrically connected to each other in series or in parallel. For the sake of simplicity and clarity, the electric connections (which may be realized by, for example, busbars or wires) are not shown in the figures. Also, for each group of battery cells, the battery cells included in the group are electrically interconnected to each other, most often in series. This is similarly not shown for the sake of simplicity.

Moreover, it is indicated by the hatching in FIG. 3 that the space between the base portion 10 and the base cover 20 is completely filled with a coolant F. The coolant F can be supplied to the space 30 between the base portion 10 and the base cover 20 via the inlet I and discharged from the space 30 via the outlet O, as discussed above with reference to FIG. 2. As can be seen, the base portion 10 provides a safe fluid-proof separation of the spaces within the compartments 41, 42, 43 where the groups of battery cells 81, 82, 83 are accommodated and the space between the base portion 10 and the base cover 20. Nonetheless, each of the groups of battery cells 81, 82, 83 is cooled from several sides. As can be further seen, with reference to the orientation of the battery module 1 as shown in FIG. 3, a bottom side of each of the groups of battery cells 81, 82, 83 positively and completely abuts against the base area 410, 420, 430 of the respective compartment 41, 42, 43. Also, for any one of the groups of battery cells 81, 82, 83, each of the lateral sides positively abuts against one of the side walls of the respective compartment. For example, the left lateral side of the first group of battery cells 81 positively abuts against the left side wall 41a of the first compartment 41 as shown in FIGS. 2 and 3, and, correspondingly, the right lateral side of the first group of battery cells 81 positively abuts against the right sidewall 41b of the first compartment 41. Similarly, the remaining two lateral sides of the first group of battery cells 81 each positively abut against the respective adjacent sidewall 41c, 41d of the first compartment 41. Accordingly, heat exchange between the group of battery cells and the coolant F occurs through the base area as well as through each of the side walls of the respective compartments, which accommodates the group of battery cells. This can also be seen from FIG. 4, which provides the cross-sectional view through the first embodiment of the battery module 1 along the virtual plane that intersects the line C-C in FIG. 2 and is parallel to the y-z-plane of the coordinate system. FIG. 4 illustrates that the coolant F (indicated by the hatching) is present in any one of the interstices 32a, 32b, 34a, 34b between neighbored compartments and the interstices 36a, 36b, 36c, 36d between the side covers 22a, 22b, 22c, 22d and the respective adjacent compartments such that the coolant F flows around any one of the side walls of each of the compartments 41, 42, 43, 44, 45, 46, 47, 48, 49.

Compared to conventional cooling systems, in which groups of stacked battery cells are typically only cooled from one side (e.g., the bottom side), embodiments of the present disclosure provide improved cooling. In more detail, the illustrated first embodiment of the battery module 1 according to the present disclosure, each of the groups of battery cells 81, 82, 83 is not only cooled from the bottom side (e.g., the side facing the base area 410, 420, 430 of the respective compartment 41, 42, 43) but additionally, and different from conventional cooling systems, from each of the lateral sides (e.g., the four sides facing the side walls of the respective compartment, as an example with reference to the first compartment 41, the four sidewalls 41a, 41b, 41c, and 41d). Thus, five of the six side faces of each of the groups of battery cells can be cooled in the first embodiment of the battery module 1 as shown in FIGS. 1 to 4. Thus, an optimal cooling effect can be achieved by the battery module 1 according to embodiments of the present disclosure.

Furthermore, in the case of a thermal event, such as a thermal run-away, a thermal propagation from the group of battery cells being affected by the thermal event to the neighbored groups of battery cells and, possibly, across the whole battery module 1 can be effectively prevented due to the presence of the coolant between any two neighbored groups of battery cells (see, e.g., FIG. 4). This effect is increased by the movement of the coolant within the space between the base portion 10 and the base cover 20 due to a supply of fresh coolant via the inlet I and a discharge of used coolant via the outlet O.

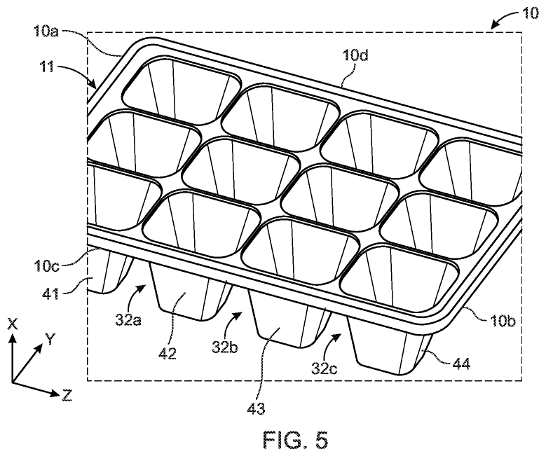

FIG. 5 schematically illustrates the perspective view of another example of a base portion 10 that can be used in another embodiment of the battery module 1 according to the present disclosure. In this embodiment, the base portion 10 includes an essentially rectangular plate 11 with rounded corners and has four side edges 10a, 10b, 10c, 10d. The plate 11 extends, along the virtual first plane, parallel to the y-z-plane of the included Cartesian coordinate system. In the plate 11, a number of indentations (e.g., twelve indentations) are arranged in a 3×4-matrix pattern. In more detail, four rows of indentations are arranged in parallel along the z-direction, and each of the rows of indentations includes three indentations arranged along the y-direction.

Each of the indentations has a similar shape. The indentations protrude from the plate 11 against the x-direction. The indentations have a flat base portion arranged parallel to the y-z-plane. With regard to the flat base portion 10, each of the side walls of the indentations are inclined by an angle greater than about 90°. Thus, when viewing against the x-direction, the indentations have each a tapering appearance.

Each of the indentations forms a compartment 41, 42, 43, 44 configured to accommodate a group of battery cells. The base portion 10 shown in FIG. 5 may be manufactured as one piece by injection molding or die casting. To build a battery module 1 according to the present disclosure, a base cover is arranged beneath the base portion 10. The base cover may be connected with the base portion 10 in a similar manner as described above with reference to FIGS. 2 and 3 to form a sealed space between the base portion 10 and the base cover.

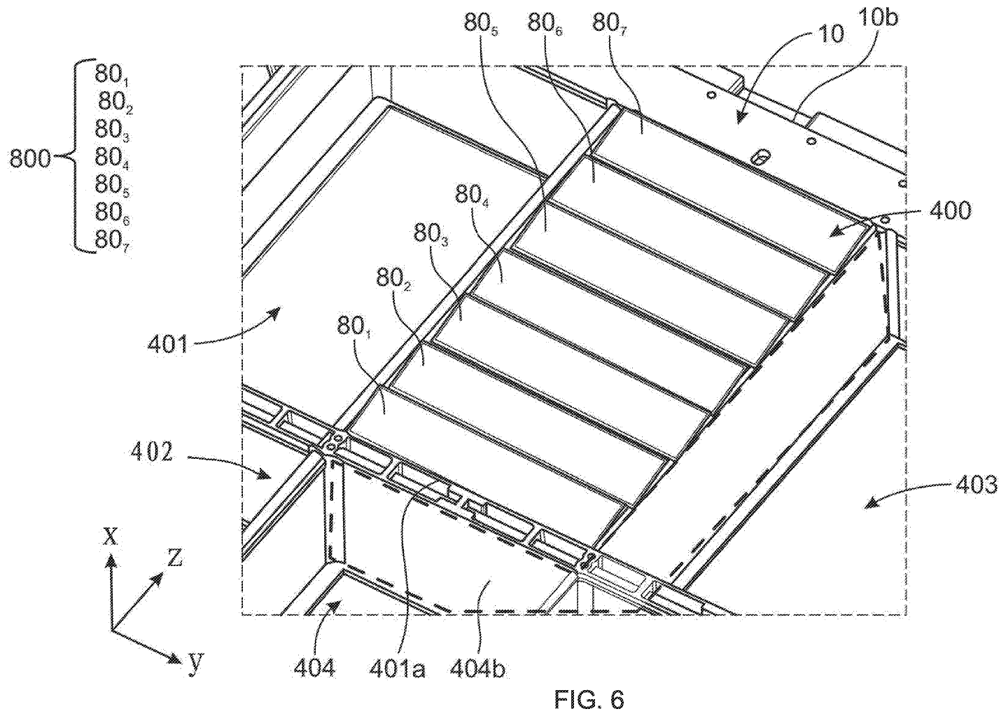

FIG. 6 shows schematically parts of another embodiment of the battery module 1 according to the present disclosure. In this embodiment, a cell compartment having seven cells is shown from the inside of the battery module. The battery cells are encased by a die cast structure, which is configured to receive coolant, for example water, such that the battery cells are encased by a “coolant jacket” when the die cast structure is filled with coolant.

The base portion 10 includes a plurality of indentations, each of which forms a compartment 400, 401, 402, 403, 404 (the compartment 400 being arranged between the compartments 401 and 403). Further indentations/compartments may be arranged along and/or against the y-direction and against the z-direction. A group of battery cells 800 is accommodated in the compartment 400, which is formed by the prismatic battery cells 80₁, 80₂, 80₃, 80₄, 80₅, 80₆, 80₇ stacked together along the z-direction. The group of battery cells 800 has a cuboid shape positively abutting with each of its lateral faces against the side wall of the compartment 400 and, additionally, with its bottom face abutting against the base area of the compartment 400. For the sake of simplicity, electrical harnesses, such as terminals on the individual battery cells 80₁, 80₂, 80₃, 80₄, 80₅, 80₆, 80₇, and the electrical connections between the battery cells are not shown in the figure.

The compartment 400 is separated from each of the neighbored compartments 401, 403, 404 (with respect to the y-direction and the z-direction) by a double-wall formed by the side wall of the compartment 400 and the adjacent side wall of the respective neighbored compartment. Between each of these double-walls, interstices are formed, which can be filled with coolant (see the above explanations with respect to FIGS. 2 to 4). For example, with reference to the orientation of the battery module 1 as shown in FIG. 6, an interstice is formed between the front side wall 401a of the compartment 400 accommodating the group of battery cells 800 and the rear side wall 404b of the compartment 404 shown in the foreground of the figure. Also, an interstice is formed between the rear side wall of the compartment 400 and a side cover that extends parallel to the x-y-plane of the coordinate system beneath the rear side edge 10b. Thus, the compartment 400 is surrounded, at each four side walls, by interstices that can be filled with coolant. Moreover, as similarly described above with reference to FIGS. 2 and 3, a space is formed beneath a base area of the compartment 400. Thus, when each of the interstices surrounding the compartment 400 as well as the space formed beneath the base area of the compartment 400 is filled with coolant, the group of battery cells 800 is in thermal contact with the coolant at each of its lateral faces as well as at its bottom face. Thus, the interstices surrounding the compartment 400 and the space formed beneath the base area of the compartment 400 can be considered as a coolant jacket (or cooling jacket) surrounding the group of battery cells 800 at each of its sides except for the top side. The cooling system is fully external and there are no fluid-connectors to the inside of the battery necessary.

In the above-described design, the “coolant jacket” is formed directly into the casting without a costly core.

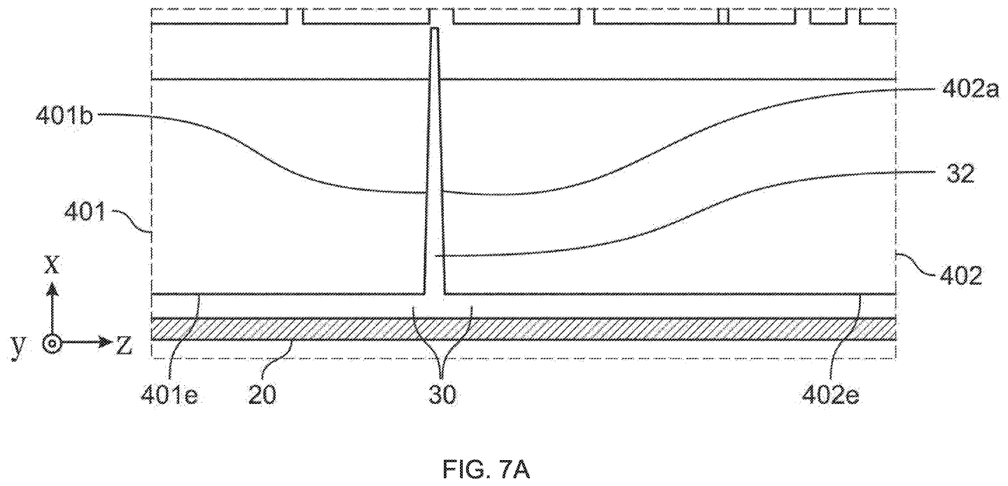

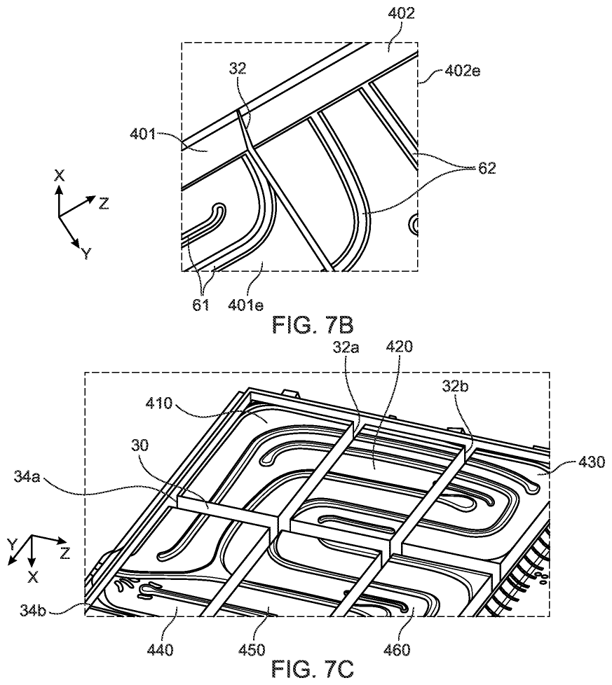

FIG. 7A shows again a schematic cross-sectional view through an embodiment of the battery module 1 according to the present disclosure. Two compartments 401 and 402 (being part of a base portion) are shown arranged above the base cover 20. The base area 401e of the compartment 401 and the base area 402e of the compartment 402 are each spaced apart from the base cover 20 with respect to the x-direction. An interstice 32 is formed between the compartments 401 and 402. The interstice 32 is connected (linked, open to, or in fluid communication with) to the space 30. Thus, when coolant is guided into the space 30, the coolant moves into the interstice 32 and up through the interstice 32. Accordingly, in this situation, both compartments 401 and 402 are cooled at their respective base areas 401e, 402e by the coolant provided in this space 30, and, additionally, the right side wall 401b of the compartment 401 as well as the left side wall 402a of the compartment 402 are each cooled by the coolant present in the interstice 32 (the terms “left” and “right” referring here to the view depicted in FIG. 7A).

FIG. 7B shows the embodiment shown in FIG. 7A in a perspective view with the base cover 20 omitted for convenience. FIG. 7B is a bottom to top view of the embodiment shown in FIG. 7A along the x-direction. The interstice 32 is a wedge-shaped protrusion into the gap between the compartments 401 and 402. On each of the base areas 401e, 402e of the compartments 401, 402, streaming beds or semi-tube-like structures are provided. These streaming beds or semi-tube-like structures are formed by elevated structures (e.g., ridges) 61, 62 arranged on the side of the base areas 401e, 402e of the compartments 401, 402 that faces against the x-direction (e.g., toward or to the base cover 20).

FIG. 7C is a perspective bottom view of (parts of) a modified embodiment of the battery module 1 shown in FIGS. 1 to 4. The base areas 410, 420, 430, 440, 450, 460 of the compartments 41, 42, 43, 44, 45, 46, respectively, are shown in FIG. 7C. On each of the base areas, streaming beds or semi-tube-like structures are formed by elevated structures similar to that as described above with reference to FIG. 7B. Between any two neighbored base areas (with respect to the y-direction and the z-direction), the entrance to an interstice formed between the respective compartments is visible. Thus, the entirety of the entrances to the interstices 32a, 32b, 34a, 34b as shown in FIG. 7C has a net-like shape and, accordingly, the entirety of the interstices 32a, 32b, 34a, 34b has a ribbing (or ribbed) structure. With reference to FIG. 7C, the base cover is arranged above the base areas 410, 420, 430, 440, 450, 460 by a certain distance d₁ (see, e.g., FIG. 2). Then, a space 30 is formed between the base areas 410, 420, 430, 440, 450, 460 and the base cover. The space 30 is linked (connected) to each of the interstices 32a, 32b, 34a, 34b via the entrances to the interstices as shown in FIG. 7C. Accordingly, when that the space 30 is filled with coolant, the coolant penetrates through the entrances to the interstices 32a, 32b, 34a, 34b.

As illustrated in FIGS. 7A to 7C with reference to a section of a battery housing (e.g., the base portion and/or the base cover), the cooling system designed as a “coolant jacket” may be created around a cell compartment (e.g., a compartment with seven battery cells as shown in FIG. 6). This ribbing structure may be approximately as high as the cell (with respect to the x-direction).

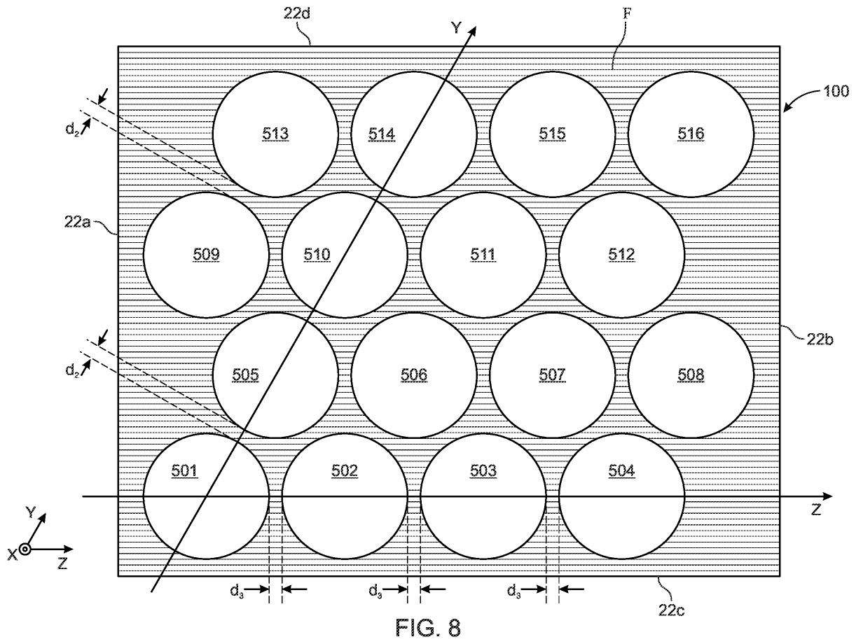

FIG. 8 schematically illustrates a cross-sectional view through another embodiment of a base portion 100 that can be included in an embodiment of the battery module according to the present disclosure. The base portion 100 is similar to the base portion 10 depicted in FIGS. 1 to 4 except for the number and shape of the indentations/compartments and the spatial arrangement thereof. For example, the base portion 100 includes an essentially flat plate extending along the first virtual plane parallel to the y-z-plane of the coordinate system and has a plurality of indentations protruding against the x-direction. However, different from the first embodiment shown in FIGS. 1 to 4, the indentations each have a circular shape, when viewed along the x-direction. For example, the indentations each form a cylindrical compartment 501, 502, 503, 504, 505, 506, 507, 508, 509, 510, 511, 512, 513, 514, 515, 516, that is, the compartments have each a cylindrically shaped side wall. Each of the base areas of the indentations may be flat and may extend along a second virtual plane parallel to the y-z-plane of the coordinate system (see the respective description as to FIGS. 1 to 4). The cross-sectional view shown in FIG. 8 intersects the base portion 100 parallel to the first virtual plane such that it intersects each of the cylindrically shaped compartments.

Again, the compartments 501, 502, 503, 504, 505, 506, 507, 508, 509, 510, 511, 512, 513, 514, 515, 516 are arranged in a two-dimensional periodic pattern with respect to the y-z-plane. For example, the identically shaped compartments are arranged periodically with respect to the y-direction as well as with respect to the z-direction. Thus, any two neighboring compartments with respect to the y-direction have the same distance d₂ to each other (e.g., the compartments 501, 505, 510, 514 arranged along the line indicated by the arrow Y). Correspondingly, any two neighboring compartments with respect to the z-direction have the same distance d₃ to each other (e.g., the compartments 501, 502, 503, 504 arranged along the line indicated by the arrow Z).

However, different from the first embodiment shown in FIGS. 1 to 4, the y-direction and the z-direction are not perpendicular to each other but form an angle of 60° with respect to each other as indicated by the coordinate system in FIG. 8. Thus, in the embodiment shown in FIG. 8, the compartments 501, 502, 503, 504, 505, 506, 507, 508, 509, 510, 511, 512, 513, 514, 515, 516 are arranged in a two-dimensional pattern, and each of the inner compartments is surrounded, in a 6-fold symmetrical manner, by six next-neighboring compartments. For example, the compartment 507 is surrounded by the six next-neighboring compartments 503, 504, 508, 512, 511, and 506 (counted in anti-clockwise fashion). Despite the different shape and arrangement of the compartments, interstices between any two neighbored compartments are formed, and, also, interstices between compartments close to the side covers 22a, 22b, 22c, 22d are formed (the side covers 22a, 22b, 22c, 22d being arranged similarly as explained with reference to FIGS. 1 to 4). Moreover, each of the afore-mentioned interstices is fluidly connected (linked) to a space formed between the bottom areas of the compartments 501 to 516 and base cover arranged behind the cut shown in FIG. 8 parallel to the y-z-plane. Thus, even in embodiments including the base portion 100 depicted in FIG. 8, each of the compartments 501 to 516 are thermally in contact with the coolant F at the base area and the cylindrical side wall when the space between the base portion 100 and the base cover is filled with coolant. Thus, even with this construction, optimal cooling of each of the groups of battery cells accommodated in the plurality of compartments is provided. It this embodiment, the groups may each formed by cylindrical battery cells stacked together along the center axis of their cylindrical shapes.

### SOME REFERENCE SIGNS

1 battery module
10 base portion
10a, 10b, 10c, 10d side edges of base portion
11 plate
20 base cover
20a, 20b side edges of base cover
22a, 22b, 22c, 22d side covers
30 space
32, 32a, 32b interstices
34a, 34b interstices
36a, 36b interstices
40 plurality of compartments
41, 42, 43, 44, 45, 46, 47, 48, 49 compartments
41a, 41b, 41c, 41d side walls of first compartment
42a, 42b side walls of second compartment
43a, 43b side walls of third compartment
61, 62 elevated structures
80₁, 80₂, 80₃, 80₄, 80₅, 80₆, 80₇ battery cells
80₁₁, 80₁₂, 80₁₃, 80₁₄, 80₁₅, 80₁₆, 80₁₇ battery cells
81, 82, 83 groups of battery cells
100 base portion (alternative embodiment)
400, 401, 403, 404 compartments
401a, 402a, 402b side walls
401e, 402e base areas
410, 420, 430, 440, 450, 460 base areas
501-516 cylindrical compartments
800 group of battery cells
A-A, B-B, C-C lines indicating intersections
Δ, d₁, d₂, d₃ distances
F coolant
I inlet
O outlet
x, y, z axes of a coordinate system
Y, Z arrows

What is claimed is:

1. A battery module comprising:
a base portion extending along a first virtual plane that is perpendicular to a first direction, the base portion comprising a plurality of indentations protruding against the first direction;
a base cover extending along a second virtual plane that is parallel to the first virtual plane and arranged in front of the first virtual plane when viewing into the first direction, the base cover being spaced apart from each of the indentations; and
a plurality of groups of battery cells,
wherein each of the indentations forms a compartment configured to accommodate at least one of the groups of battery cells,
wherein each of the groups of battery cells is accommodated in one of the compartments, and
wherein a space is formed between neighboring ones of the indentations.

2. The battery module according to claim 1, wherein the base portion is formed as one piece by injection molding or die casting.

3. The battery module according to claim 1, wherein an edge of the base portion is continuously sealed with the base cover.

4. The battery module according to claim 1, wherein the base cover and the base portion are formed together as one piece by injection molding or die casting.

5. The battery module according to claim 1, wherein each of the indentations has a base area, and
wherein the base area is the area of the indentations having a maximal distance to the first virtual plane.

6. The battery module according to claim 5, wherein the base area of at least for one of the indentations extends parallel to the first virtual plane.

7. The battery module according to claim 5, wherein the base area of each of the indentations has the same distance to the first virtual plane.

8. The battery module according to claim 5, wherein each of the base areas has an oval or circular shape.

9. The battery module according to claim 5, wherein each of the base areas has a rectangular shape.

10. The battery module according to claim 5, wherein sides of at least some of the base areas facing the base cover comprise an elevated structure forming one or more streaming beds or semi-tube-like structures configured to guide a coolant across the sides.

11. The battery module according to claim 1, wherein the indentations have side walls extending parallel to the first direction.

12. The battery module according to claim 1, wherein each of the indentations has an identical shape.

13. The battery module according to claim 1, wherein the indentations are arranged in a two-dimensional periodic pattern with regard to the first virtual plane.

14. The battery module according to claim 1, wherein a side of the base cover facing the base portion comprises an elevated structure forming one or more streaming beds or semi-tube-like structures configured to guide a coolant across the side.

15. The battery module according to claim 1, wherein the battery cells in at least some of the groups of battery cells are stacked along the first direction.

16. The battery module according to claim 1, wherein the battery cells in at least some of the groups of battery cells are stacked in a direction perpendicular to the first direction.

17. A battery pack comprising at least one of the battery modules according to claim 1.

18. A vehicle comprising at least one of the battery modules according claim 1.

19. A vehicle comprising at least one of the battery packs according to claim 17.
